(19) United States
(12) Patent Application Publication
(10) Pub. No.: US 2024/0329226 A1
(43) Pub. Date: Oct. 3, 2024

(54) Method for Operating a Radar Sensor for Distance Measurement and Corresponding Radar Sensor

(71) Applicant: KROHNE S.A.S., Romans-sur-Isère Cedex (FR)

(72) Inventors: Samuel Grosdidier, Beauregard-Baret (FR); Olivier Dubray, Chatuzange-Le-Goubet (FR)

(21) Appl. No.: 18/615,342

(22) Filed: Mar. 25, 2024

(30) Foreign Application Priority Data
Mar. 27, 2023 (DE) 10 2023 107 687.6

(51) Int. Cl. G01S 13/20; G01F 23/292; G01S 7/292

(52) U.S. Cl. CPC G01S 13/20; G01F 23/292; G01S 7/2927

(57) ABSTRACT

A method for operating a radar sensor includes: emitting a signal; receiving a receive signal having first and second reflection pulses; determining receive times and amplitudes for the first and second reflection pulses; and determining distance information from the receive times. The detection step includes: setting an initial receive time and an initial maximum as the receive time and amplitude of the first reflection pulse; generating a first difference signal by subtracting from the receive signal a first reference pulse having the receive time and amplitude of the first reflection pulse, and using the same to determine the receive time and amplitude of the second reflection pulse; and generating a second difference signal by subtracting from the receive signal a second reference pulse having the receive time and amplitude of the second reflection pulse, and using the same to determine the receive time and amplitude of the first reflection pulse.

### TECHNICAL FIELD

The invention relates to a method for operating a radar sensor for distance measurement, wherein the radar sensor transmits a transmit signal, receives a receive signal with a temporally extended amplitude profile comprising at least a first reflection pulse with a first receive time and a first amplitude and a second reflection pulse with a second receive time and a second amplitude wherein in a detection step a first determined receive time and a first determined amplitude are determined from the receive signal as approximate values for the first receive time and the first amplitude of the first reflection pulse and a second determined receive time and a second determined amplitude are determined as approximate values for the second receive time and the second amplitude of the second reflection pulse, and wherein distance is information is calculated from the determined receive times. Furthermore, the invention also relates to a radar sensor for distance measurement, comprising a transmitting element for transmitting a transmitting signal, a receiving element for receiving a transmitting signal, and a signal processing unit, wherein the signal processing unit carries out the aforementioned method during operation of the radar sensor.

### BACKGROUND

Radar sensors of the aforementioned type have been known for many years, for example from the field of process measurement technology, in which a typical task is, for example, to determine fill levels of a medium in a container. There are essentially two measuring principles by means of which distance information is obtained. In pulse radar, a radar pulse with a narrow time span is emitted as a transmit signal, finally reflected by an object in the propagation path of the transmit signal, and the reflected transmit signal is then picked up again by the radar sensor as a receive signal. From the signal propagation time, the distance to the reflected object can be determined directly based on the known propagation speed of the transmitted signal (speed of light in a vacuum or possibly in a known medium). In FMCW radar (frequency modulated continuous wave), a frequency modulated continuous signal is emitted as a transmit signal, which is also reflected by the reflective object and returns to the radar sensor as a frequency modulated continuous signal as a receive signal. Due to the known time rate of change of the frequency of the radar signal, the difference frequency between the transmit signal and the receive signal is a direct measure for the time offset of both signals, thus for the transit time of the receive signal and for the distance of the reflection object. According to both methods, it is possible to plot the receive signal over a time axis, even if the FMCW radar initially operates in the frequency domain. The method considered here and explained in the following can be applied to both methods of distance measurement. In the following, the consideration in the time domain is always selected.

Radar pulses are not pulses in the mathematical sense, but rather also have a temporal expansion in which the signal intensity increases, reaches a maximum and then drops again. In exactly the same way, reflected radar pulses, i.e. the reflection pulses, also have a temporal expansion. After passing through the reflection path, this can be even greater than the temporal expansion of the generated transmitted signal before passing through the is reflection path due to various properties of the medium in the reflection path and possibly also of the reflection object.

Problematic measurement situations arise when two reflection pulses arrive at the radar sensor so close together in time that they merge into one another due to their own temporal expansion and are practically only received as a single receive signal. Reflection objects that are very close to each other can be formed, for example, by thin layers of liquids (e.g., thin oil layer on water) or by moving objects in the medium that temporarily pass through the detection range of the radar (e.g., stirring device). If the consideration is initially limited to only two overlapping reflection pulses, then in the example shown the situation is that the receive signal has a temporally extended amplitude profile and comprises a first reflection pulse with a first receive time and a first amplitude and a second reflection pulse with a second receive time and a second amplitude. This description is accompanied by the notion that the reflection pulses have a characteristic amplitude profile, wherein the amplitude in each case means the maximum amplitude and the receive time means the time at which the maximum amplitude is present. The amplitudes and the receive times of the two reflection pulses are the actual, i.e. error-free characteristic parameters of the reflection pulses.

In the prior art, various methods are known for extracting the first reflection pulse and the second reflection pulse from the receive signal in a detection step so that the best possible estimates for the first receive time and the second receive time of the first reflection pulse and the second reflection pulse are obtained. This is what is meant when it is said that, in the detection step, a first determined receive time and a first determined amplitude are determined from the receive signal as approximate values for the first receive time and the first amplitude of the first reflection pulse, and that, of course, a second determined receive time and a second determined amplitude are also determined from the receive signal as approximate values for the second receive time and the second amplitude of the second reflection pulse.

In the prior art, for example, it is known to approximate the first reflection pulse and the second reflection pulse from the receive signal by applying an inverse convolution operation (deconvolution) to the receive signal convolved with the transfer function of the reflection path, wherein the transfer function of the reflection path is known to be the impulse response of the reflection path. In practice, the Fourier transforms of the receive signal and the impulse response of the reflection path are multiplied (which corresponds in the frequency domain to convolution in the time domain) and the inverse Fourier transform is applied to them (after normalization, if necessary). It is readily apparent that this process is relatively complex and is not or only poorly executable with the limited capabilities (computing capacity and also power supply) of radar sensors as are frequently used in the industrial sector (in particular 2-wire technology).

### SUMMARY

It is therefore the object of the present invention to design the method described at the beginning in such a way that the determined amplitudes and the determined receive times can be determined as approximate values for the parameters of the reflection pulses with comparatively little effort.

In the case of the method mentioned at the outset and in the case of the radar sensor mentioned at the outset, the derived object is initially and essentially achieved by the disclosed features, namely in that, in the detection step, at least one reference reflection pulse with a reference amplitude, a reference receive time and a reference intensity profile is initially determined. The reference reflection pulse is used practically as a blueprint for possible reflection pulses. This is done under the assumption that the receive signal can be approximated by a combination of such reference reflection pulses, which can be shifted in time with respect to each other and have different amplitudes. The reference reflection pulse can be determined by using a calculated reference reflection pulse or a reflection pulse previously captured by measurement in an undisturbed environment. The measurement-based reflection pulse may have been captured by the installed radar sensor itself in the actual installation situation, but it may also be a reflection pulse captured under factory conditions—for example, during factory calibration—or the reflection pulse captured by another radar sensor.

In an initial detection step, an initial maximum is set as a value for the first determined amplitude and an initial receive time is set as a value for the first determined receive time. For the initial maximum and the initial receive time, estimated values can be used in the simplest case. The method described in full below works iteratively and converges to the actual solution. As with other iterative methods, the number of iterations can be reduced by appropriate choice of initial values to achieve a required accuracy.

For the initial maximum and/or the initial receive time, known values can also be used, for example of obstacles in the detection range of the radar sensor. In such a case, for example, the initial receive time would be known, but possibly not the initial amplitude, for which an estimated value could then be used. In the course of the method, the receive time would then practically not change as a result of the iterative calculation, but the amplitude would.

In a first partial detection step, a difference receive signal is now generated in that the reference reflection pulse with the first determined amplitude as reference amplitude and with the first determined receive time as reference receive time is subtracted from the receive signal. The reference reflection pulse is thus parameterized with the characteristic data (amplitude and receive time) which were determined in the initial detection step. The first approximation of one of the reflection pulses is thus subtracted from the receive signal. From the resulting difference receive signal, the second determined receive time and the second determined amplitude are determined by means of peak detection. The receive signal is thus adjusted from the first estimate of one of the two reflection pulses so that the other reflection pulse is more prominent in the difference receive signal.

In a second partial detection step, the difference receive signal is then generated again by subtracting the reference detection pulse with the second determined amplitude as the reference amplitude and with the second determined receive time as the reference receive time from the receive signal. Thereby the difference receive signal is obtained from the receive signal, in which now the effects of the first reflection pulse are more clearly emphasized. The first determined receive time and the first determined amplitude are then determined from the differential receive signal by means of peak detection as the best approximation for the corresponding values of the first reflection pulse.

According to a preferred design of the method, it is provided that the first partial detection step and the second partial detection step are carried out in several iterations in succession. This results in a continuous improvement of the approximate values for the first receive time and the first amplitude of the first reflection pulse and for the second determined receive time and the second determined amplitude.

In a preferred further development of the method, the iterations are terminated if the change in the first determined receive time or/and the change in the second determined receive time from one iteration step to the subsequent iteration step falls below a predetermined limit. As a result, the convergence towards the final state of the corresponding approximate values is aborted at least for the receive times of the reflection pulses when falling below an approximate limit.

In an alternative termination criterion, it is provided that the iterations are terminated when a measure associated with the difference receive signal falls below a threshold value, in particular wherein the measure associated with the difference receive signal and the threshold value with respect thereto is a power measure of the difference receive signal.

In a further alternative termination criterion, it is provided that the iterations are terminated when a measure associated with a complete difference receive signal falls below a threshold. The complete difference receive signal is obtained in that both the reference reflection pulse with the first determined amplitude as reference amplitude and with the first determined receive time as reference receive time is subtracted from the receive signal, and the reference reflection pulse with the second determined amplitude as reference amplitude and with the second determined receive time as reference receive time is subtracted from the receive signal. Preferably, the limit value is related to the power of the complete differential receive signal, thus the amplitude values enter here quadratically into the measure.

In a preferred design of the method, it is provided that, in the initial detection step, an initial maximum in the amplitude curve of the receive signal and its initial receive time are determined and the initial maximum is set as a value for the first determined amplitude and the initial receive time is set as a value for the first determined receive time. Thus, a maximum is detected in the receive signal and it is assumed that this maximum and the initial receive time associated with the initial maximum are characteristic of one of the received reflection pulses. This approach yields quite good initial values, in any case usually better than when using estimated values without further reference.

According to a preferred design of the method, it is provided that in the initial detection step the absolute maximum in the amplitude response of the receive signal is used as the initial maximum. The advantage here is that the absolute maximum can be determined with a high degree of certainty.

In a preferred design of the method, the reference reflection pulse is determined in that the reference reflection pulse has been stored in the radar sensor and is only read out. Preferably, several reference reflection pulses are stored in the radar sensor, for example for different media in the path of the transmitted signal. This can be useful because different media can influence and deform the reflection signal differently on its way from the radar sensor is to the reflection object and back to the radar sensor, for example due to deviating dispersion properties.

The reference reflection pulse can be a calculated reflection pulse or a measured reflection pulse.

In another design of the method, the reference reflection pulse is determined by the reference reflection pulse being received by the radar sensor in the established operational environment. This means that the radar sensor emits a transmit pulse as a transmit signal—as in the subsequent operation—into the propagation path, wherein care is taken that only a single reflection pulse results and is received as a receive signal. The advantage of this procedure is that the reference reflection pulse is actually adapted to the transmission characteristics of the reflection path. The measured reflection pulse can also have been recorded under factory conditions, for example during factory calibration. The reference reflection pulse can also have been recorded by another radar sensor.

A preferred design of the aforementioned methods with regard to the determination of the reference reflection pulse is that the reference reflection pulse is determined for different measured distance information or, in any case, has been stored for different measured distance information, and the reference reflection pulse having the best match with the distance information in the specific measurement situation is used to carry out the method. This procedure is particularly useful if the transmission path has a relatively large influence on the signal shape of the radar signal passing through, for example in the case of media with a high dispersion. In this case, the receive signal actually changes noticeably in dependence on the length of the propagated path, i.e., in dependence on the measured distance, so that a corresponding adjustment in the choice of the reference reflection pulse for carrying out the method is useful.

A further preferred design of the method is characterized in that at least a first and a second reference reflection pulse are determined, each with a reference amplitude, a reference receive time and a reference intensity curve, and that the first reference reflection pulse is used in the first partial detection step and the second reference reflection pulse is used in the second partial detection step. This procedure is useful if the two reflection signals have different amplitude characteristics—i.e. signal shapes—due to their history of origin, i.e. reflection, for example, at different boundary layers. In this case, subtracting the corresponding reference reflection pulses from the receive signal results in more precise difference receive signals.

The method described above is not only applicable with two reflection pulses, but also with more than two reflection pulses. Therefore, in a further development of the method, it is provided that first a number n of the reflection pulses contained in the receive signal is determined, for example by peak detection or other analytical or statistical evaluation of the receive signal. In the initial detection step, n−1 initial maxima in the amplitude response of the receive signal and their initial receive times are then determined. The initial maxima are set as values for the determined amplitudes and the initial receive times are set as values for the determined receive times. Then a corresponding number of n partial detection steps is carried out in the detection step, wherein in the i-th partial detection step all n−1 reference reflection pulses except the i-th reference reflection pulse are subtracted from the receive signal, wherein the reference reflection pulses are parameterized accordingly with the approximate values for amplitude and receive time. The i-th determined receive time and the i-th determined amplitude are determined from the differential receive signal thus obtained by means of peak detection. The principle underlying the extended method is the same as for the method described on the basis of two reflection pulses: the best estimates of all reflection pulses are subtracted from the receive signal, so that only the effect of a single reflection pulse remains. By evaluating this single reflection pulse, better approximations are then obtained for the parameters of this reflection pulse, i.e. for amplitude and receive time.

The object described above is achieved in the radar sensor under consideration for distance measurement, with a transmitting element for transmitting the transmit signal and with a receiving element for receiving the receive signal, and with a signal processing unit, in that the signal processing unit is designed in such a way that, during operation of the radar sensor, it carries out the method described above.

### BRIEF DESCRIPTION OF THE DRAWINGS

In detail, there is now a large number of possibilities for designing and further developing the method according to the invention for operating a radar sensor and the corresponding radar sensor. For this, reference is made to the following description of embodiments in connection with the drawings.

FIG. 1 schematically illustrates a typical application situation of a radar sensor for distance measurement.

FIGS. 2a and 2b schematically illustrate a receive signal with a temporally extended amplitude profile with reflection pulses running into each other.

FIG. 3 illustrates the receive signal from FIGS. 2a and 2b with a first reflection pulse and a second reflection pulse.

FIGS. 4a and 4b schematically illustrate the determination of a reference reflection pulse.

FIGS. 5a and 5b schematically illustrate a first partial detection step in first iteration stage.

FIGS. 6a and 6b schematically illustrate a second part detection step in first iteration stage.

FIGS. 7a and 7b schematically illustrate a first part detection step in second iteration stage.

FIGS. 8a and 8b schematically illustrate a second part detection step in second iteration stage.

FIGS. 9a and 9b schematically illustrate a first partial detection step in third iteration stage.

FIG. 10 schematically illustrates at progressive iterations the results for the first determined receive time and the second determined receive time as well as for the first determined amplitude and the second determined amplitude as approximate values for the parameters of the first receive pulse and the second receive pulse.

### DETAILED DESCRIPTION

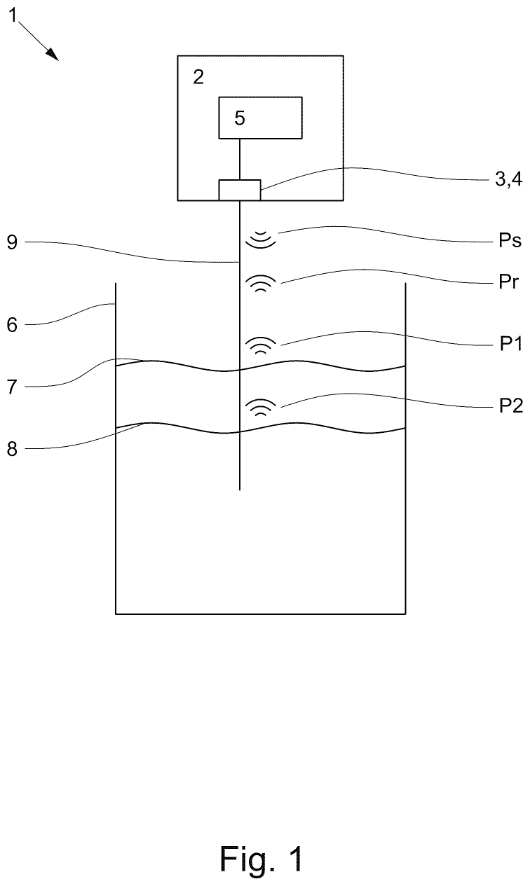

In FIGS. 1 to 10, various aspects of a method 1 for operating a radar sensor 2 for distance measurement are shown and, in part, a corresponding radar sensor 2 is also shown.

The radar sensor 2 shown in FIG. 1 is a wired radar sensor in which a transmit signal Ps is emitted by a transmitting element 3 and in which the transmit signal Ps propagates in a guided manner along a measuring cable. This arrangement falls under the term “wired radar”, also called time-domain reflectometry. However, the special design of the radar sensor 2 is not important; it could just as easily work with freespace waves as the transmitted signal Ps. In the application situation shown, the measuring cable projects into a container 6 in which there are two liquid media. The medium closest to the is radar sensor 2 forms a first interface 7 with the surrounding atmosphere, and the two liquid media form a second interface 8 with each other. A concrete example of such a measurement situation would be an oil layer floating on an aqueous medium.

At the boundary surfaces 7, 8, reflections occur in the form of a first reflection pulse P1 and a second reflection pulse P2 due to the changing wave transmission properties. Since the transmitted signal Ps already has a certain temporal expansion, the reflection pulses P1, P2 naturally also have a certain temporal expansion. If these reflection pulses P1, P2 are close together in time, then the reflection pulses P1, P2 merge into each other. The receive signal Pr received by a receive element 4 then has a temporally extended amplitude curve in which the individual reflection pulses P1, P2 can no longer be easily distinguished—or can only be distinguished with difficulty. However, such a distinguishability of the temporal separation of the first reflection pulse P1 and the second reflection pulse P2 is necessary in order to be able to obtain distance information, in the present case, how far apart the two boundary layers 7, 8 are from each other.

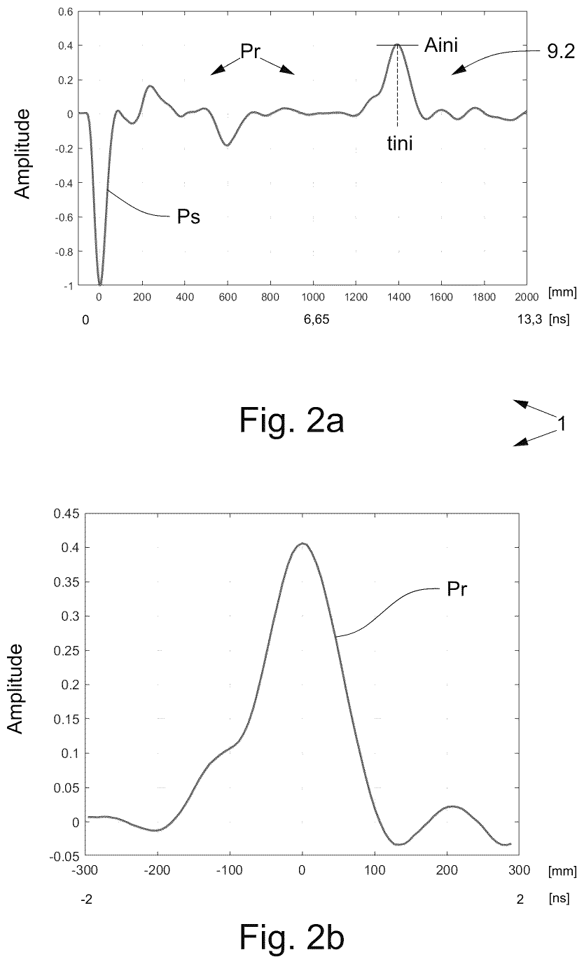

FIG. 2a shows the time sequence from the emission of the receive signal Ps at time zero and the subsequent amplitude profile of the receive signal Pr. In FIGS. 2a and 2b the signal profile is plotted in each case over a time axis and over a location axis, wherein time and location stand in a fixed relationship to one another, since the transit time of the signal is synonymous with a distance covered in this time accordingly. As already in the general description, also in the figure description in the following it is always spoken of receive times, independently of whether the represented signals are plotted over the time or over a corresponding location coordinate.

In FIG. 2a it can be seen that the transmitted signal Ps is initially followed by two temporally very close but well distinguishable reflection pulses resulting from the mounting flanges of the radar sensor 2. In the right part of the signal profile, the receive signal Pr with a relatively large amplitude can be recognized; this is the receive signal Pr that is actually of interest. This part of the receive signal Pr is again more clearly highlighted in FIG. 2b.

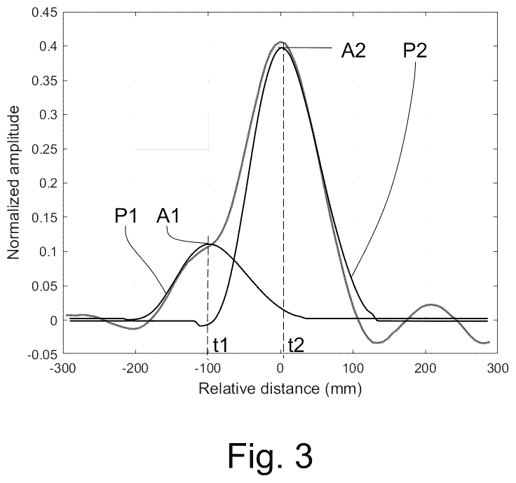

FIG. 3 shows the temporally extended amplitude curve of the receive signal Pr, which receives a first reflection pulse P1 with a first receive time t1 and a first amplitude A1 and a second reflection pulse P2 with a second receive time t2 and a second amplitude A2. The methods shown in the following figures have is in common that, in a detection step 9, a first determined receive time t1det and a first determined amplitude A1det are determined from the receive signal Pr as approximate values for the first receive time t1 and the first amplitude A1 of the first reflection pulse P1 and a second determined receive time t2det and a second determined amplitude A2det are determined as approximate values for the second receive time t2 and the second amplitude A2 of the second reflection pulse P2. This is the prerequisite for being able to calculate distance information for the reflection pulses P1, P2 from the determined receive times t1det, t2det. The trick is to extract these reflection pulses P1, P2 from the coherent receive signal Pr with reflection pulses P1 and P2 running into each other in terms of signals and to determine the best possible approximations for the first receive time t1 and the second receive time t2 in the form of the first determined receive time t1det and the second determined receive time t2det.

In the detection step 9, a plurality of method steps 9.1, 9.2, 9.3 and 9.4 are carried out.

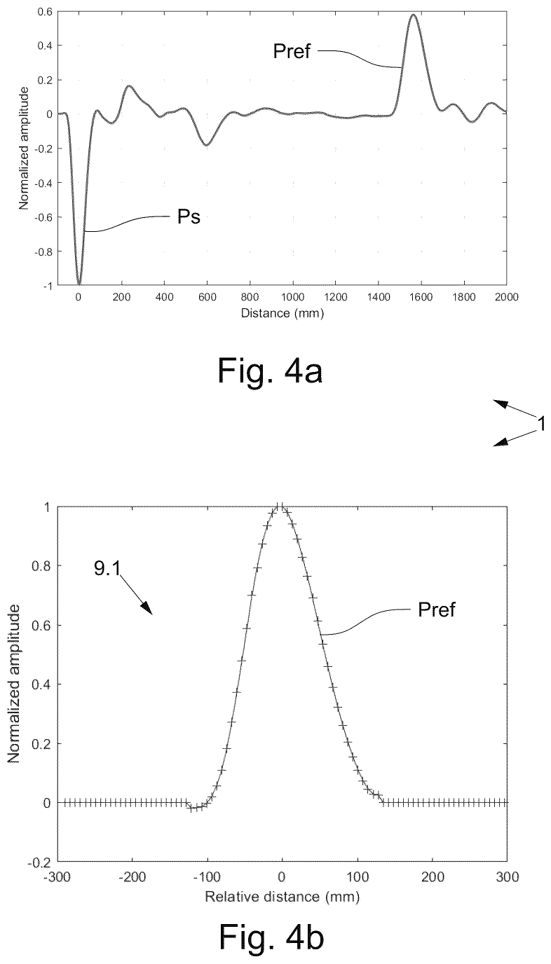

FIGS. 4a and 4b show that first a reference reflection pulse Pref is determined 9.1. For this purpose, a single transmit signal Ps in the form of a transmit pulse is applied to the measurement path, wherein care is taken that only a single reflection signal returns as receive signal Pr. This receive signal Pr is characteristic of the transmission behavior of the measuring section. The idea of the present method 1 lies in the assumption that each receive signal Pr can be represented by a superposition of several reference reflection pulses which are offset in time and possibly differ in amplitude. FIG. 4b shows the reference reflection pulse Pref normalized to amplitude 1 and receive time zero, which has a reference intensity curve (amplitude curve). Accordingly, the reference reflection pulse can be used to simulate any receive signals Pr by determining a reference amplitude Aref and a reference receive time tref (P(t)=Aref*Pref(t−tref)=Pref (Aref, tref)).

The task now is to determine a good estimate for the first reflection pulse P1 and the second reflection pulse P2 from the receive signal Pr as shown in FIGS. 2a and 2b.

For this, in an initial detection step 9.2 (FIG. 2), an initial maximum Aini in the amplitude response of the receive signal Pr and its initial receive time tini are determined. Furthermore, the initial maximum Aini is set as the value for the first determined amplitude A1det and the initial receive time tini is set as the value for the first determined receive time t1det. In FIG. 2b the maximum of the receive signal Pr has been set to the time value or location value zero, this representation has been retained for the most part in the following figures.

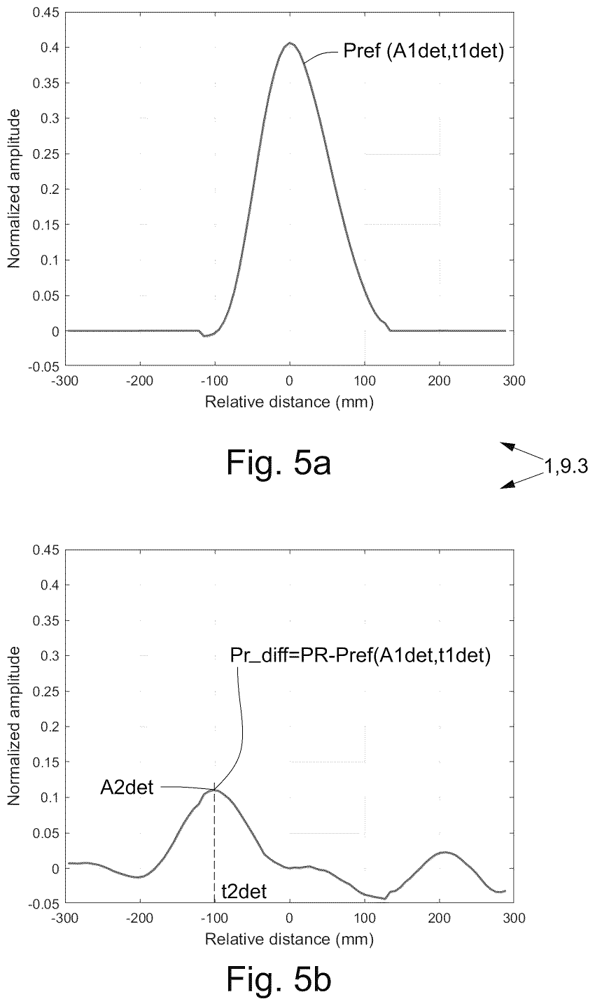

FIG. 5a, 5b show a first partial detection step 9.3. A difference receive signal Pr_diff (FIG. 5b) is generated in that the reference reflection pulse Pref (FIG. 5a) with the first determined amplitude A1det as reference amplitude Aref and with the first determined receive time t1det as reference receive time tref is subtracted from the receive signal Pr, thus the operation Pr_diff=Pr−Pref(A1det, t1det) is executed; the result is shown in FIG. 5b. From the difference receive signal Pr_diff, the second determined receive time t2det and the second determined amplitude A2det are determined by means of peak detection. As already explained above, the determined receive time is always present where the determined amplitude, i.e. the determined amplitude maximum, is present.

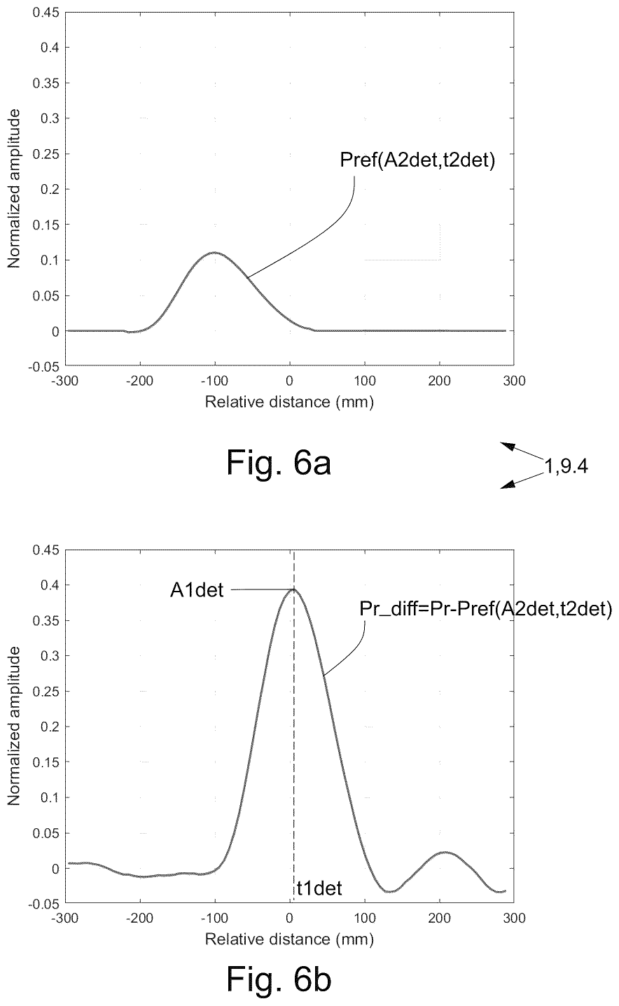

In a second partial detection step 9.4, shown in FIGS. 6a, 6b, the difference receive signal Pr_diff is generated (FIG. 6b) in that the reference reflection pulse Pref (FIG. 6a) with the second determined amplitude A2det as reference amplitude Aref and with the second determined receive time t2det as reference receive time tref (Pr_diff=Pr−Pref(A2det, t2det)) is subtracted from the receive signal Pr. New values for the first determined receive time t1det and the first determined amplitude A1det are then determined from the difference receive signal P diff by means of peak detection.

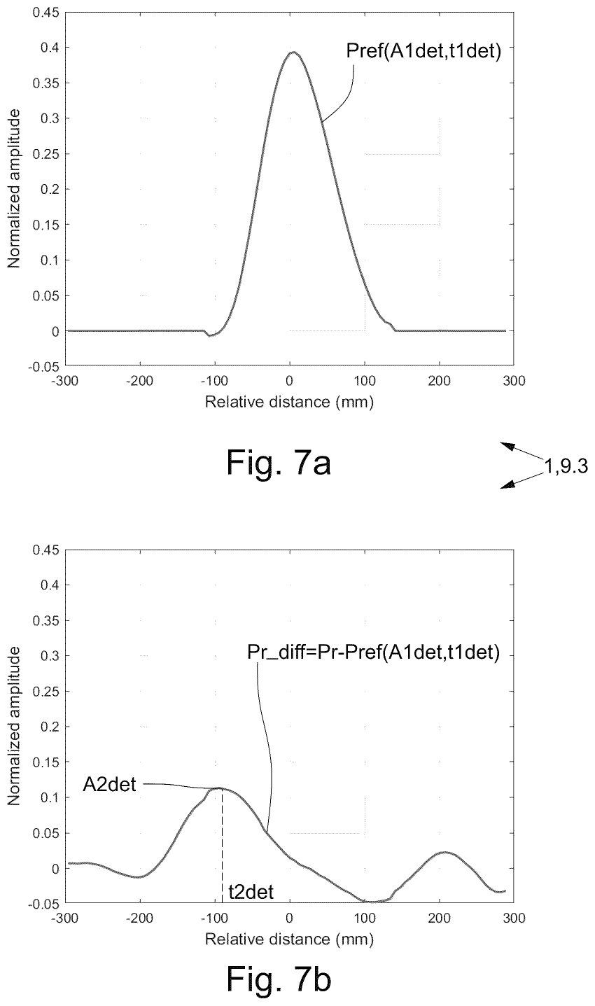

As can be seen from FIGS. 7 to 9, method 1 is carried out in several iterations. The first partial detection step 9.3 and the second partial detection step 9.4 are performed alternately in several iterations in succession.

FIGS. 7a, 7b show the first partial detection step 9.3 in second iteration. The difference receive signal Pr_diff (FIG. 7b) is generated in that the reference reflection pulse Pref (FIG. 7a) with the first determined amplitude A1det as reference amplitude Aref and with the first determined receive time t1det of the last iteration stage as reference receive time tref is subtracted from the receive signal Pr, thus the operation Pr_diff=Pr−Pref(A1det, t1det) is executed; the result is shown in FIG. 7b. The second determined receive time t2det and the second determined amplitude A2det are determined from the difference receive signal Pr_diff by means of peak detection.

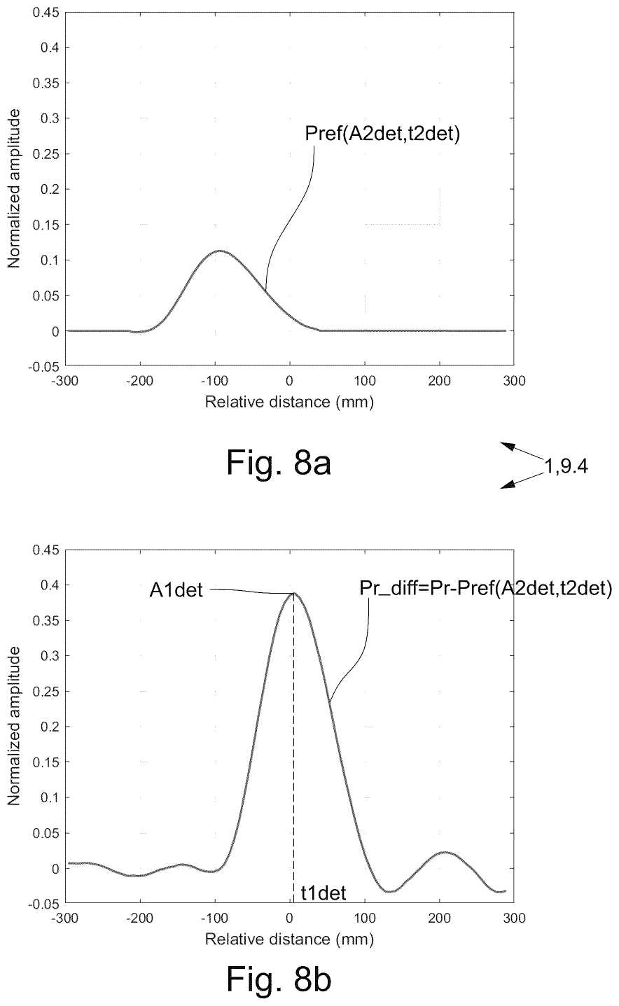

In the further, second partial detection step 9.4, now in second iteration, shown in FIGS. 8a, 8b, the difference receive signal Pr_diff is generated (FIG. 8b) by is subtracting the reference reflection pulse Pref (FIG. 8a) with the second determined amplitude A2det as reference amplitude Aref and with the second determined receive time t2det as reference receive time tref of the last iteration stage from the receive signal Pr (Pr_diff=Pr−Pref(A2det, t2det)). New values for the first determined receive time t1det and the first determined amplitude A1det are then determined again from the difference receive signal P_diff using peak detection.

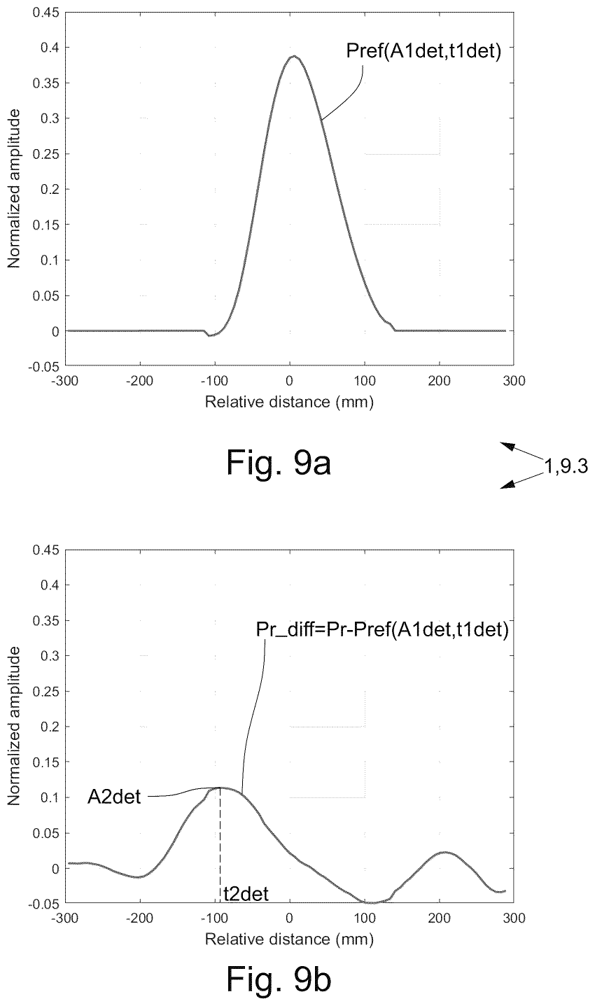

FIGS. 9a, 9b show the first partial detection step 9.3 in the third iteration. The procedure is similar to that in the previous iterations.

In the embodiment shown, the iterations are aborted because the change in the first determined receive time t1det and the change in the second determined receive time t2det from one iteration step to the next iteration step have fallen below a predetermined limit.

As can be seen from FIG. 2a, the method 1 has been implemented in such a way that in the initial detection step 9.2 the absolute maximum in the amplitude curve of the receive signal Pr has been used as the initial maximum Aini.

Furthermore, in the method 1 illustrated, see FIG. 2, it has been implemented that the reference reflection pulse Pref has been picked up by the radar sensor 2 in the configured deployment environment.

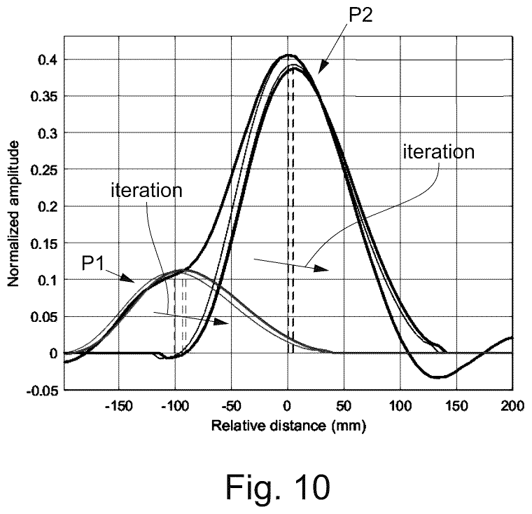

FIG. 10 illustrates the results for the first determined receive time t1det, the second determined receive time t2det as well as for the first determined amplitude A1det and the second determined amplitude A2det as approximate values for the parameters of the first receive pulse P1 and the second receive pulse P2, which have been continuously improved with progressive iterations.

1. A method for operating a radar sensor for distance measurement, comprising:
emitting a transmitted signal from the radar sensor;
receiving a receive signal at the radar sensor, the receive signal having a temporally extended amplitude profile including at least a first reflection pulse with a first receive time and a first amplitude and a second reflection pulse with a second receive time and a second amplitude;
in a detection step, determining a first determined receive time and a first determined amplitude from the receive signal as approximate values for the first receive time and the first amplitude of the first reflection pulse, determining a second determined receive time and a second determined amplitude as approximate values for the second receive time and the second amplitude of the second reflection pulse, and determining distance information from the first determined receive time and the second determined receive time;
wherein the detection step includes:
determining a reference reflection pulse with a reference amplitude, a reference receive time and a reference intensity curve;
in an initial detection step, setting an initial maximum as a value for the first determined amplitude and setting an initial receive time as a value for the first determined receive time;
in a first partial detection step, generating a difference receive signal in that the reference reflection pulse with the first determined amplitude as the reference amplitude and with the first determined receive time as the reference receive time is subtracted from the receive signal and the second determined receive time and the second determined amplitude are determined from the difference receive signal by means of peak detection; and
in a second partial detection step, generating the difference receive signal is generated in that the reference reflection pulse with the second determined amplitude as the reference amplitude and with the second determined receive time as the reference receive time is subtracted from the receive signal and the first determined receive time and the first determined amplitude are determined from the difference receive signal by means of peak detection.

2. The method according to claim 1, wherein the first partial detection step and the second partial detection step are carried out in several iterations in succession.

3. The method according to claim 2, wherein the iterations are aborted if at least one of: (i) the change in the first determined receive time from one iteration step to the next iteration step falls below a predetermined limit; and (ii) the change in the second determined receive time from one iteration step to the next iteration step falls below a predetermined limit.

4. The method according to claim 2, wherein the iterations are terminated when a measure associated with the difference receive signal falls below a limit value; and
wherein the measure associated with the difference receive signal and the limit value relating thereto is a performance measure of the difference receive signal.

5. The method according to claim 2, wherein the iterations are aborted when a measure associated with a complete difference receive signal falls below a limit value;
wherein the complete difference receive signal is obtained in that the reference reflection pulse with the first determined amplitude as the reference amplitude and with the first determined receive time as the reference time is subtracted from the receive signal and that the reference reflection pulse with the second determined amplitude as reference amplitude and with the second determined receive time as reference receive time is subtracted from the receive signal; and
wherein the measure associated with the complete difference receive signal and the limit value with respect thereto is a power measure of the complete difference receive signal.

6. The method according to claim 1, wherein in the initial detection step, the initial maximum in the amplitude curve of the receive signal and its initial receive time are determined and the initial maximum is set as the value for the first determined amplitude and the initial receive time is set as the value for the first determined receive time; and
wherein the absolute maximum in the amplitude response of the receive signal is used as the initial maximum.

7. The method according to claim 1, wherein the reference reflection pulse has been stored in the radar sensor and is only read out; and
wherein a plurality of reference reflection pulses have been stored in the radar sensor, for different media in the path of the transmitted signal.

8. The method according to claim 1, wherein the reference reflection pulse is received by the radar sensor in the configured deployment environment.

9. The method according to claim 7, wherein the reference reflection pulse is determined for different measured distance information and the reference reflection pulse having the best correlation with the distance information in the specific measurement situation is used to carry out the method.

10. The method according to claim 1, wherein at least a first and a second reference reflection pulse each having a reference amplitude, a reference receive time and a reference intensity curve are determined; and
wherein the first reference reflection pulse is used in the first partial detection step and the second reference reflection pulse is used in the second partial detection step.

11. The method according to claim 1, wherein a number n of the reflection pulses contained in the receive signal is determined;
wherein, in the initial detection step, n−1 initial maxima in the amplitude profile of the receive signal and their initial receive times are determined, and the initial maxima are set as values for the determined amplitudes and the initial receive times are set as values for the determined receive times; and
wherein a corresponding number of n partial detection steps is carried out in the detection step, wherein, in the i-th partial detection step, all n−1 reference reflection pulses except for the i-th reference reflection pulse are subtracted from the receive signal and the i-th determined receive time and the i-th determined amplitude are determined from the difference receive signal by means of peak detection.

12. A radar sensor for distance measurement, comprising:
a transmitting element for transmitting a transmit signal;
a receiving element for receiving a receive signal having a temporally extended amplitude profile including at least a first reflection pulse with a first receive time and a first amplitude and a second reflection pulse with a second receive time and a second amplitude; and
a signal processing unit to perform a detection step including:
determining a first determined receive time and a first determined amplitude from the receive signal as approximate values for the first receive time and the first amplitude of the first reflection pulse;
determining a second determined receive time and a second determined amplitude as approximate values for the second receive time and the second amplitude of the second reflection pulse; and
determining distance information from the first determined receive time and the second determined receive time;
wherein the detection step performed by the signal processing unit further includes:
determining a reference reflection pulse with a reference amplitude, a reference receive time and a reference intensity curve;
in an initial detection step, setting an initial maximum as a value for the first determined amplitude and setting an initial receive time as a value for the first determined receive time;
in a first partial detection step, generating a difference receive signal in that the reference reflection pulse with the first determined amplitude as the reference amplitude and with the first determined receive time as the reference receive time is subtracted from the receive signal and the second determined receive time and the second determined amplitude are determined from the difference receive signal by means of peak detection; and
in a second partial detection step, generating the difference receive signal in that the reference reflection pulse with the second determined amplitude as the reference amplitude and with the second determined receive time as the reference receive time is subtracted from the receive signal and the first determined receive time and the first determined amplitude are determined from the difference receive signal by means of peak detection.

13. The radar sensor according to claim 12, wherein the first partial detection step and the second partial detection step are carried out in several iterations in succession.

14. The radar sensor according to claim 13, wherein the iterations are aborted if at least one of: (i) the change in the first determined receive time from one iteration step to the next iteration step falls below a predetermined limit; and (ii) the change in the second determined receive time from one iteration step to the next iteration step falls below a predetermined limit.

15. The radar sensor according to claim 13, wherein the iterations are aborted when a measure associated with a complete difference receive signal falls below a limit value;
wherein the complete difference receive signal is obtained in that the reference reflection pulse with the first determined amplitude as the reference amplitude and with the first determined receive time as the reference time is subtracted from the receive signal and that the reference reflection pulse with the second determined amplitude as reference amplitude and with the second determined receive time as reference receive time is subtracted from the receive signal; and
wherein the measure associated with the complete difference receive signal and the limit value with respect thereto is a power measure of the complete difference receive signal.

16. The radar sensor according to claim 12, wherein in the initial detection step, the initial maximum in the amplitude curve of the receive signal and its initial receive time are determined and the initial maximum is set as the value for the first determined amplitude and the initial receive time is set as the value for the first determined receive time; and
wherein the absolute maximum in the amplitude response of the receive signal is used as the initial maximum.

17. The radar sensor according to claim 12, wherein the reference reflection pulse has been stored in the radar sensor and is only read out; and
wherein a plurality of reference reflection pulses have been stored in the radar sensor, for different media in the path of the transmitted signal.

18. The radar sensor according to claim 12, wherein the reference reflection pulse is received by the radar sensor in the configured deployment environment; and
wherein the reference reflection pulse is determined for different measured distance information and the reference reflection pulse having the best correlation with the distance information in the specific measurement situation is used to carry out the method.

19. The radar sensor according to claim 12, wherein at least a first and a second reference reflection pulse each having a reference amplitude, a reference receive time and a reference intensity curve are determined; and
wherein the first reference reflection pulse is used in the first partial detection step and the second reference reflection pulse is used in the second partial detection step.

20. The radar sensor according to claim 12, wherein a number n of the reflection pulses contained in the receive signal is determined;
wherein, in the initial detection step, n−1 initial maxima in the amplitude profile of the receive signal and their initial receive times are determined, and the initial maxima are set as values for the determined amplitudes and the initial receive times are set as values for the determined receive times; and
wherein a corresponding number of n partial detection steps is carried out in the detection step, wherein, in the i-th partial detection step, all n−1 reference reflection pulses except for the i-th reference reflection pulse are subtracted from the receive signal and the i-th determined receive time and the i-th determined amplitude are determined from the difference receive signal by means of peak detection.
